(19) United States
(12) Patent Application Publication
(10) Pub. No.: US 2014/0299417 A1
(43) Pub. Date: Oct. 9, 2014

(54) LIFTING APPARATUS

(71) Applicant: MOBOT INDUSTRIES LIMITED, Auckland (NZ)

(72) Inventor: Steven Theo Haythorne, Auckland (NZ)

(73) Assignee: MOBOT INDUSTRIES LIMITED, Auckland (NZ)

(21) Appl. No.: 14/352,953

(22) PCT Filed: Oct. 23, 2012
(86) PCT No.: PCT/NZ2012/000192

§ 371 Date: Apr. 18, 2014

(30) Foreign Application Priority Data
Oct. 21, 2011 (NZ) 595924

(51) Int. Cl. B66F 9/20; B66F 9/075

(52) U.S. Cl. CPC B66F 9/20; B66F 9/075
USPC 187/224; 187/222

(57) ABSTRACT

A lifting apparatus with a first and a second drive wheel aligned about an axis of rotation. The lifting apparatus structure has a longitudinal dimension defined perpendicular to the axis or rotation and adapted to rotatably support the first and second drive wheels. The lifting apparatus has at least one motive device adapted to drive, either together or independently, the first and second drive wheels. The lifting apparatus structure further supports a lifting mechanism with a lifting surface longitudinally offset from the first and second drive wheels.

### FIELD OF INVENTION

This invention broadly relates to lifting apparatus and in particular a maneuverable lifting apparatus.

### BACKGROUND

In the manufacturing, transportation and warehousing industry there exist palletised loads that must be transported. Traditional apparatus used to transport small palletised loads include hand trucks, such as shown in FIG. 1. Advantages of hand trucks are that they are small, light and maneuverable. However, hand trucks are hand operated and therefore limited in their use by the physical characteristics of those who operate them. As such, hand trucks are viewed as being labour intensive and best suited useful for transporting light loads short distances.

A motorised ‘Walk Behind’ apparatus capable of surpassing the lifting ability of hand trucks is shown in FIG. 2. A walk behind is a powered pallet jack capable of lifting heavy loads and can be moved without relying on the strength of the operator. However, the maneuverability this device is limited by its long dimensions and limited ground clearance. A further disadvantage of the walk behind apparatus is the rear located steering mechanism that requires a relatively large floor area in which to make a turn.

A motorised ‘Stacker’ apparatus is shown in FIG. 3. A stacker provides an advantage over a hand truck and a walk behind apparatus by providing a lifting mechanism that allows a palletised load to be lifted onto a truck bed. However, the stacker apparatus is similarly limited in maneuverability by its long dimensions, limited ground clearance, and rear located steering mechanism.

A further apparatus for moving palletised loads is the conventional forklift, such as shown in FIG. 4. Such forklifts are heavy, cumbersome and relatively un-maneuverable. The smallest conventional forklifts weigh 3 ton and are designed to move 1500 kg palletised loads.

In the baking industry, and in particular in bread manufacture, there exists a need to move a large number of compact stacked loads that are most suitably transported by hand trucks due to their dimension and weight. A typical stack of palletised bread loaves is shown in FIG. 5, while a typical warehouse full of palletised bread loaves to be arranged and transported is shown in FIG. 6. Typically bread is baked at bakeries, packed into crates and distributed through a network of trucks, thus requiring an intensive inventory sorting and stacking system.

As hand trucks are hand operated, they are relatively slow for transportation of such palletised loads, especially in a large warehouse environment. Further, as the pallets typically used in the baking industry have a narrow base area, the stack can become unstable when lifted and transported at pace, introducing the potential for an accident to occur. For health and safety requirements, a hand truck capable of carrying a stack of bread crates 20 crates high may be limited to a stack carrying 12 crates high, thereby surrendering 40% of the potential carrying capacity.

There therefore exists the need for a forklift having the maneuverability of a hand truck apparatus with the lifting and mobility capabilities of a powered forklift apparatus.

It is therefore an object of the present invention to provide a forklift apparatus that overcomes or ameliorate the abovementioned disadvantages, or at least provides the public with a useful choice. Other objects of the invention may become apparent from the following description which is given by way of example only.

### SUMMARY OF THE INVENTION

In one broad aspect the invention consists in a lifting apparatus comprising first and second drive wheels aligned about and spaced along an axis of rotation, a structure having a longitudinal dimension defined perpendicular to the axis of rotation of the drive wheels and adapted to rotatably support, and balance about the axis of rotation of, the first and second drive wheels, at least one motive device adapted to drive, either together or independently, the first and second drive wheels such that motion of the lifting apparatus is effected, and the lifting apparatus comprising a lifting mechanism longitudinally offset from the lifting apparatus.

In another broad aspect the invention consists in a lifting apparatus comprising one or more forward support wheels and one or more aft support wheels, first and second drive wheels aligned about and spaced along an axis of rotation and located between the one or more forward support wheels and one or more aft support wheels, a structure having a longitudinal dimension defined perpendicular to the axis or rotation of the drive wheels and adapted to rotatably support, and balance about the axis of rotation of the first and second drive wheels, at least one motive device adapted to drive, either together or independently, the first and second drive wheels such that motion of the lifting apparatus is effected, a lifting mechanism supported by the lifting apparatus, and a control system configured to balance the lifting apparatus substantially about the centre of rotation of the driving wheels by controlling motion of the drive wheels and output a signal to energise the at least one motive device to drive the first and second driving wheel in the same direction, drive the first and second driving wheel in opposing directions, drive the first wheel while the second wheel is stationary, or drive the second wheel while the first wheel is stationary.

In another broad aspect the invention consists in a lifting apparatus comprising one or more forward support wheels and one or more aft support wheels, first and second drive wheels aligned about and spaced along an axis of rotation, the drive wheels located between the one or more forward support wheels and one or more aft support wheels, a structure having a longitudinal dimension defined perpendicular to the axis of rotation of the drive wheels and adapted to rotatably support, and substantially balance about the axis of rotation of, the first and second drive wheels, a lifting mechanism supported by the lifting apparatus, a first actuation device adapted to raise and lower the one or more forward support wheels, a second actuation device adapted to raise and lower the one or more aft support wheels, and at least one motive device adapted to drive, either together or independently, the first and second drive wheels.

Preferably the lifting mechanism further comprises a lifting surface and an actuator adapted to at least lower or level the lifting surface such that a load can be engaged, or raise or upwardly tilt the lifting surface such that a load can be retained on the lifting surface when the lifting apparatus is in motion.

Preferably the lifting mechanism further comprises one or more forward support wheels located between the first and second drive wheels and the lifting surface, one or more aft support wheels located longitudinally aft of the drive wheels, a first actuation device adapted to raise and lower the one or more forward support wheels, a second actuation device adapted to raise and lower the one or more aft support wheels.

Preferably the lifting mechanism further comprises a control system configured to balance the lifting apparatus and lifting mechanism about the centre of rotation of the driving wheels thereby enabling an operator to drive the lifting apparatus balanced, or substantially balanced on the drive wheels.

Preferably the first actuation device and second actuation device are independently operable to cause movement of, together or independently, the one or more forward, or aft, support wheels to at least raised, level and lowered positions with respect to a ground plane.

Preferably the lifting apparatus further comprises an actuation device adapted to displace a ballast forward and aft of the axis of rotation of the drive wheels.

Preferably the apparatus further comprises a control system configured to output a signal to energise the at least one motive device to drive the first and second driving wheel in the same direction, drive the first and second driving wheel in opposing directions, drive the first wheel while the second wheel is stationary, or drive the second wheel while the first wheel is stationary.

Preferably the control system is further configured to output a signal representative of desired movement of the lifting surface.

Preferably the control system is configured to output one or more signals representative of desired actuation of the first or second actuation devices so as to cause raising or lowering of the one or more forward support wheels, the one or more aft support wheels, or both.

Preferably the control system is configured to output a signal representative of desired actuation of the third actuator so as to cause displacement of the ballast.

Preferably the control system is configured to have input from one ox more sensors including: a load sensor adapted to measure the load on the one or more forward support wheels, one or more sensors adapted to measure the lifting apparatus speed over ground, one or more sensor adapted to measure the tilt angle of the lifting apparatus about the axis of rotation, a load sensor adapted to measure a load on the lifting surface, or a lifting mechanism control signal indicative of desired raising or lowering of the lifting surface.

Preferably the control system is configured to have input from at least an operator, or operational guidance system, including a signal indicative of desired movement of the lifting surface, a signal indicative of desired movement of the first or second drive wheel, or a signal indicative of desired movement of the first or second actuation device.

Preferably the load on the at least one front support wheel is indicative of a sloped ground plane or a load on the lifting surface.

Preferably the control system is configured to receive an input indicative of the load on the one or more forward support wheels, compare the input indicative of the load on the one or more forward support wheels to a desired load, output one or more signals to control actuation of the first or second actuation device to maintain the load on the one or more forward support wheels substantially similar to the desired load.

Preferably the step of comparing the input indicative of the load on the one or more forward support wheels to a desired load further comprises the control system configured to output a signal to cause the first actuation device to lower the one or more support wheels when the indicative load is less than the desired load, or output a signal to cause the first actuation device to raise the one or more support wheels when the indicative load is more than the desired load.

Preferably the step of comparing the input indicative of the load on the one or more forward support wheels to a desired load further comprises the control system configured to output a signal to the third actuation device move the ballast forward of the axis of rotation when the indicative load is less than the desired load, or move the ballast aft of the axis of rotation when the indicative load is more than the desired load.

Preferably the control system is configured to when the lifting apparatus is to travel at low speed cause the first actuator to raise the one or more first support wheels, cause the second actuator to level the one or more aft support wheels, cause the third actuator to displace the ballast forward of the axis of rotation of the driving wheels, and cause the lifting surface to be in a lowered or flattened position.

Preferably the control system is configured to when the lifting apparatus is to travel at a high speed cause the first actuator to level the one or more first support wheels, cause the second actuator to level the one or more aft support wheels, cause the third actuator to displace the ballast forward of the axis of rotation of the driving wheels, and cause the lifting surface to be in a lowered or flattened position.

Preferably the control system is configured to, when the lifting apparatus is to engage a load to be lifted cause the first actuator to level the one or more first support wheels, cause the second actuator to level the one or more aft support wheels, cause the third actuator to displace the ballast forward of the axis of rotation of the driving wheels, and cause the lifting surface to be in a lowered or flattened position.

Preferably the control system is configured to, when the lifting apparatus is to lift a load, cause the first actuator to level the one or more first support wheels, cause the second actuator to level the one or more aft support wheels, cause the third actuator to displace the ballast aft of the axis of rotation of the driving wheels, and cause the lifting surface to be in a raised or upwardly tilted position.

Preferably the control system is configured to, when the lifting apparatus is to move on a level surface with a load, cause the first actuator to level the one or mote first support wheels, cause the second actuator to level the one or more aft support wheels, cause the third actuator to displace the ballast aft of the axis of rotation of the driving wheels, and cause the lifting surface to be in a raised or upwardly tilted position.

Preferably the control system is configured to, when the lifting apparatus is to transition from a level surface to an inclined surface, cause the first actuator to raise the one or more first support wheels, cause the second actuator to level the one or more aft support wheels, cause the third actuator to displace the ballast aft of the axis of rotation of the driving wheels, and cause the lifting surface to be in a raised or upwardly tilted position.

Preferably the control system is further configured to, when the lifting apparatus is travel on an inclined surface, cause the first actuator to raise the one or more first support wheels, cause the second actuator to lower the one or more aft support wheels, cause the third actuator to displace the ballast aft of the axis of rotation of the driving wheels, and cause the lifting surface to be in a raised or upwardly tilted position.

Preferably the control system is further configured to, when the lifting apparatus is to transition from an inclined surface to a level surface, cause the first actuator to level the one or more first support wheels, cause the second actuator to lower the one or more aft support wheels, cause the third actuator to displace the ballast aft of the axis of rotation of the driving wheels, and cause the lifting surface to be in a raised or upwardly tilted position.

Preferably the control system is further configured to, when the lifting apparatus is to transition from a level surface to a declining surface, cause the first actuator to lower the one or more first support wheels, cause the second actuator to lower the one or more aft support wheels, cause the third actuator to displace the ballast aft of the axis of rotation of the driving wheels, and cause the lifting surface to be in a raised or upwardly tilted position.

Preferably the control system is further configured to, when the lifting apparatus is to travel on a declining surface, cause the first actuator to lower the one or more first support wheels, cause the second actuator to raise the one or more aft support wheels, cause the third actuator to displace the ballast aft of the axis of rotation of the driving wheels, and cause the lifting surface to be in a raised or upwardly tilted position.

Preferably the control system is further configured to, when the lifting apparatus is to transition from a declining surface to a level surface, cause the first actuator to level the one or more first support wheels, cause the second actuator to raise the one or more aft support wheels, cause the third actuator to displace the ballast aft of the axis of rotation of the driving wheels, and cause the lifting surface to be in a raised or upwardly tilted position.

Preferably the lifting apparatus further comprises a control system configured to output a signal to energise the at least one motive device to balance the lifting apparatus substantially about the centre of rotation of the driving wheels.

Preferably the first actuation device and second actuation device are independently operable to cause movement of together or independently, the one or more forward, or aft, support wheels to at least raised, level and lowered positions with respect to a ground plane.

Preferably the lifting apparatus comprises a first actuation device adapted to move the one or more forward support wheels and a second actuation device adapted to move the one or snore aft support wheels.

Preferably the first actuation device and second actuation device are independently operable to cause movement of, together or independently, the one or more forward, or aft, support wheels to at least raised, level and lowered positions with respect to a ground plane.

The following embodiments may relate to any of the above aspects.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement or claim, all need to be present but other features can also be present. Related terms such as “comprise” and “comprised” are to be interpreted in the same manner.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The invention will now be described by way of example only and with reference to the drawings in which:

FIG. 1 shows a hand truck.

FIG. 2 shows a motorised ‘Walk Behind’ apparatus.

FIG. 3 shows a motorised ‘Stacker’ apparatus.

FIG. 4 shows a conventional forklift.

FIG. 5 shows a typical stack of palletised bread loaves.

FIG. 6 shows a typical warehouse full of palletised bread loaves to be arranged and transported.

FIG. 7 shows a side elevation of the lifting apparatus according to an embodiment of the invention.

FIG. 8 shows a rear elevation of the lifting apparatus according to an embodiment of the invention.

FIG. 9 shows a right-hand side elevation of the lifting apparatus according to an embodiment of the invention.

FIG. 10 shows a top elevation of the lifting apparatus according to an embodiment of the invention.

FIG. 11 shows a profile view of the lifting apparatus according to an embodiment of the invention.

FIG. 12 illustrates a control system that may be associated with an embodiment of the invention.

FIG. 13 shows a lifting surface profile that may be used with an embodiment of the invention.

FIG. 14 shows a side view of the base of the lifting apparatus according to an embodiment of the invention.

FIG. 15 shows a side view of the base of an embodiment of the lifting apparatus with a forward support wheel in a raised position.

FIG. 16 shows a side view of the base of an embodiment of the lifting apparatus with a forward support wheel in a lowered position.

FIG. 17 shows a side view of the base of an embodiment of the lifting apparatus with a forward support wheel in a lowered position and a load on the lifting surface.

FIG. 18 shows a top view of an embodiment of the lifting apparatus.

FIG. 19 illustrates a further embodiment of the lifting apparatus.

FIG. 20 illustrates an example scenario that may represent the loading apparatus moving at low speed or prepared for loading or unloading.

FIG. 21 illustrates an example scenario that may represent the loading apparatus travelling at high speed while unloaded.

FIGS. 22 and 23 illustrate an example scenario that may represent the loading apparatus when transitioning from an unloaded to a loaded state.

FIG. 24 illustrates an example scenario that may represent the loading apparatus in a loaded state and travelling over level ground.

FIG. 25 illustrates an example scenario that may represent the loading apparatus encountering an inclined gradient while carrying a load.

FIG. 26 illustrates an example scenario that may represent the loading apparatus travelling up an inclined gradient while carrying a load.

FIG. 27 illustrates an example scenario that may represent the loading apparatus transitioning from an inclined surface to a level surface.

FIG. 28 illustrates an example scenario that may represent the loading apparatus transitions from a level surface to a declining surface.

FIG. 29 illustrates an example scenario that may represent the loading apparatus is travelling on a declining surface.

FIG. 30 illustrates an example scenario that may represent the loading apparatus transitioning from a declining surface to a level surface.

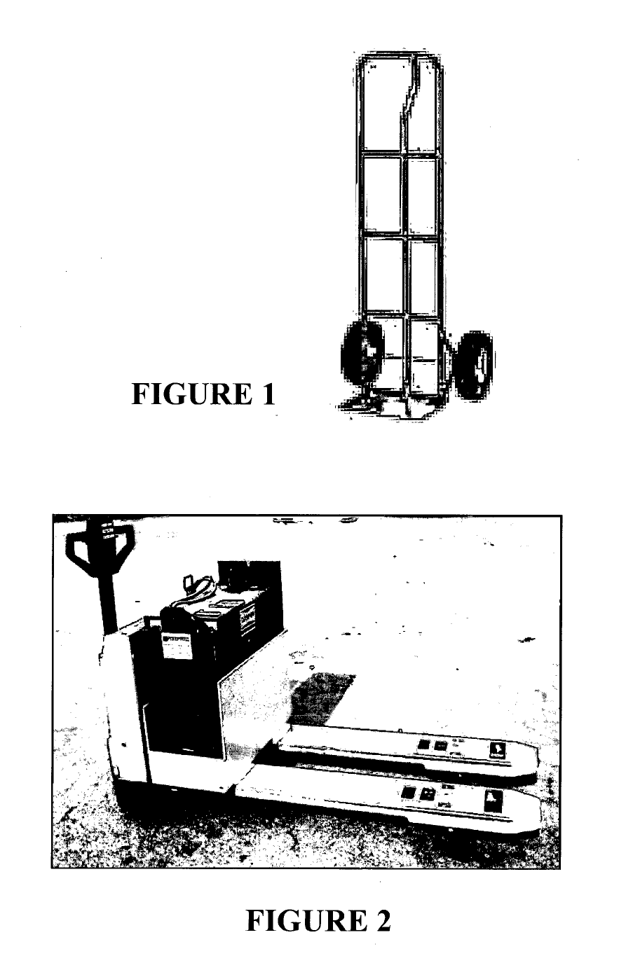

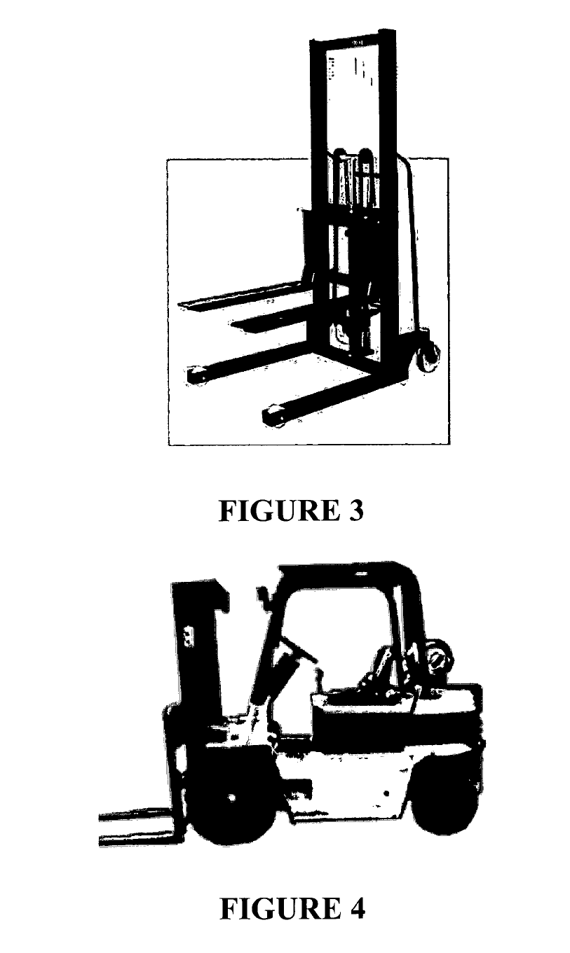

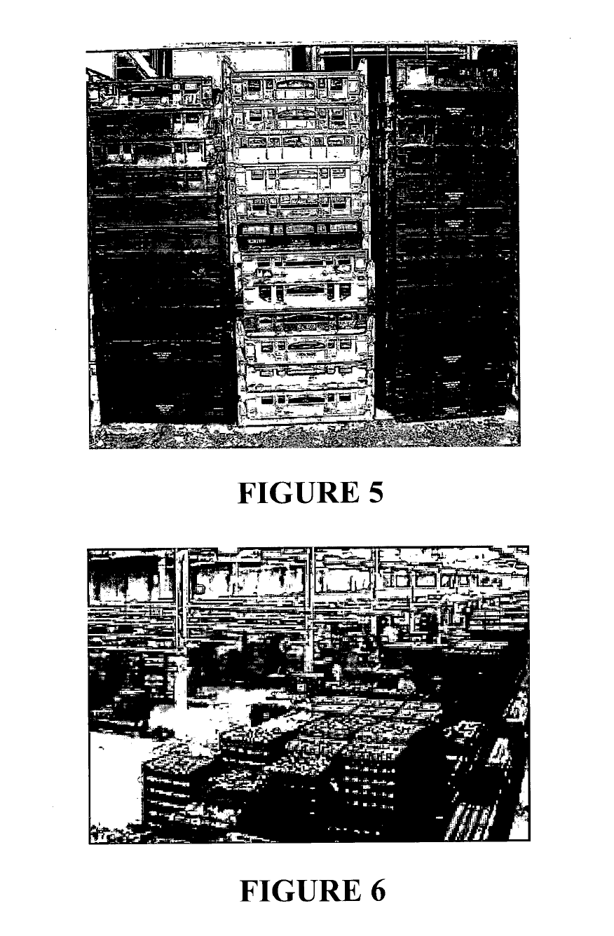

### DETAILED DESCRIPTION

Preferred embodiments relate to a lightweight and highly maneuverable lifting apparatus suitable for use in the lifting and transportation of loads, and particularly palletised loads such as milk or bread stacks. Bread stacks typically conform to a base dimension of around 685 mm square. To allow stacking of palletised loads directly into a truck for further transportation, the lifting apparatus should be operable to lift a load to a height of around 1 metre. To allow transportation of a large stack of bread crates, it is desirable that the lifting apparatus be able to lift a load of up to 170 kg. Preferably, the lifting apparatus is narrow enough to fit between rows of 685 mm bread stacks or stacks of other palletised loads in a warehousing environment. Preferably, the lifting apparatus is short enough to turn on itself in the back of a truck. The lifting apparatus is most suitable for those that have a need for repetitive movement of a standardised load size and would benefit from having maneuverability in confined spaces.

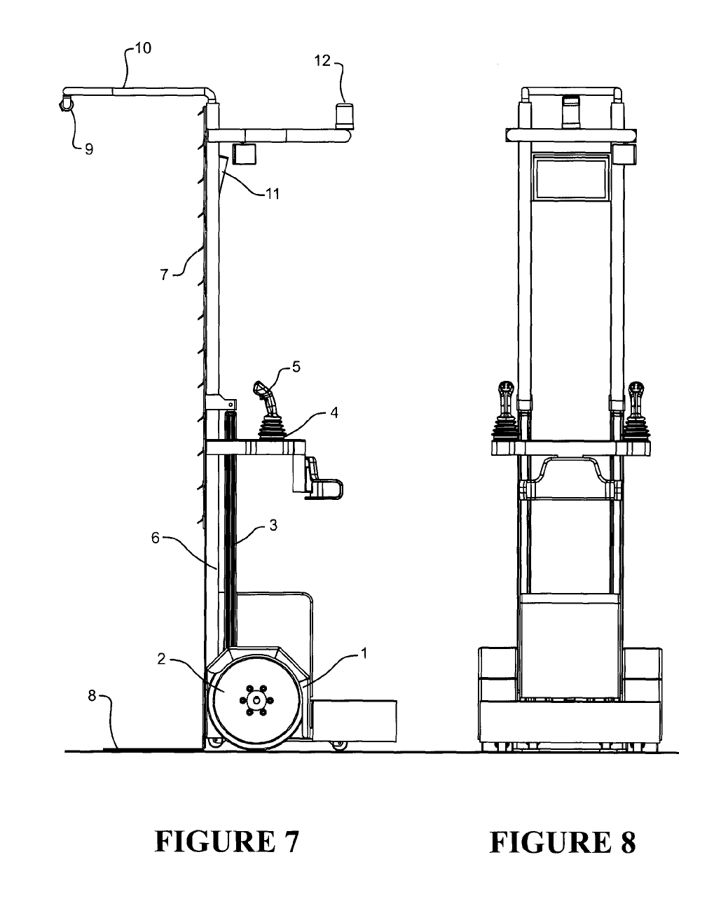

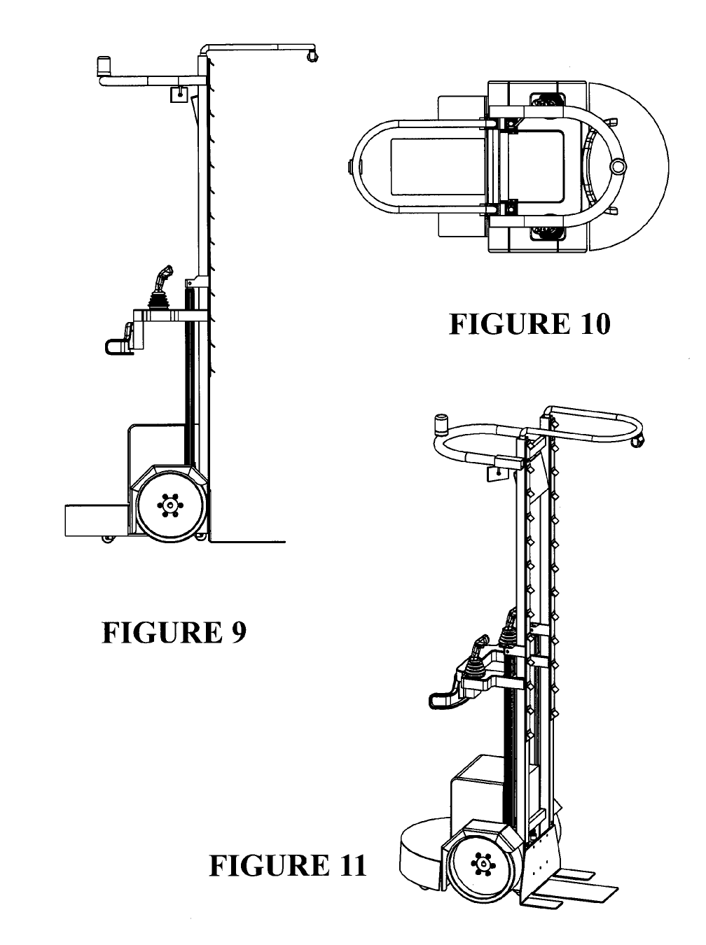

One embodiment of the lifting apparatus is shown in FIGS. 7 to 11. In particular, FIG. 7 shows a side elevation, FIG. 8 shows a rear elevation, FIG. 9 shows a right-hand side elevation, FIG. 10 shows a top elevation and FIG. 11 shows a profile view.

The lifting apparatus has a base structure 1 upon which an operator may stand or sit. However, in some embodiments the lifting apparatus may be autonomous and not require an operator.

First and second drive wheels 2 are aligned about their axis of rotation and are attached to the base structure. The drive wheels provide the primary support of the structure from the ground and are load bearing wheels during transportation of a load. The centre of balance of the structure is preferably centrally located about the drive wheels. A control system controls rotation of the drive wheels such that the centre of balance can be substantially maintained proximate the drive wheels. In an alternative embodiment of the lifting apparatus the drive wheels may be substituted with tracks. Further description relating to drive wheels as used in this specification may be read as also relating to the use of tracks.

Preferably each of the drive wheels 2 are independently rotatable. Independent rotation means the drive wheels can be rotated in the same direction, in opposite directions or one wheel can be rotated while the other wheel is stationary.

By driving the wheels 2 in opposite direction the lifting apparatus can be rotated about a pivot point located between the drive wheels. This advantageously allows the lifting apparatus to have a ‘zero turn radius’ and greatly reduces the amount of space required for the lifting apparatus to turn.

Preferably movement of each drive wheel 2 is facilitated by an electric motor positioned within the base structure and coupled to each wheel, either directly or by a transfer device. Alternatively, a single electric motor may be used and a gearbox or torque transfer device used to couple drive energy to each wheel independently of the other. In other embodiments the electric motor could be replaced with an internal combustion engine.

Preferably the drive wheels 2 are located on either side of the base structure 1. However, they may be recessed or located or housed within the base structure 1.

Preferably the base structure 1 has an upstanding support member 3 and an arm rest or guard portion member 4 attached thereto. Preferably the arm rest support 4 provides a mount for one or more control input devices 5 that an operator may be use control operation of the drive wheels and other devices that the lifting apparatus may incorporate.

The lifting apparatus includes a mechanism that is capable of engaging and lifting a load. One example of a lifting mechanism is a lifting mast operable to raise and lower a lifting surface. The lifting mast 6 is attached to the base structure 1 and optionally the upstanding support structure 3. The lifting mast 6 may have a plurality of hooks 7 to engage with apertures typically found on a pallet or crate. The hooks 7 are adapted to secure a load of stacked bread crates to the lifting mast 6 to prevent any inadvertent movement of the stack that may cause an accident. Preferably the hooks 7 may be actuated in a vertical orientation to engage and disengage with apertures in a bread stack and thereby secure the stack.

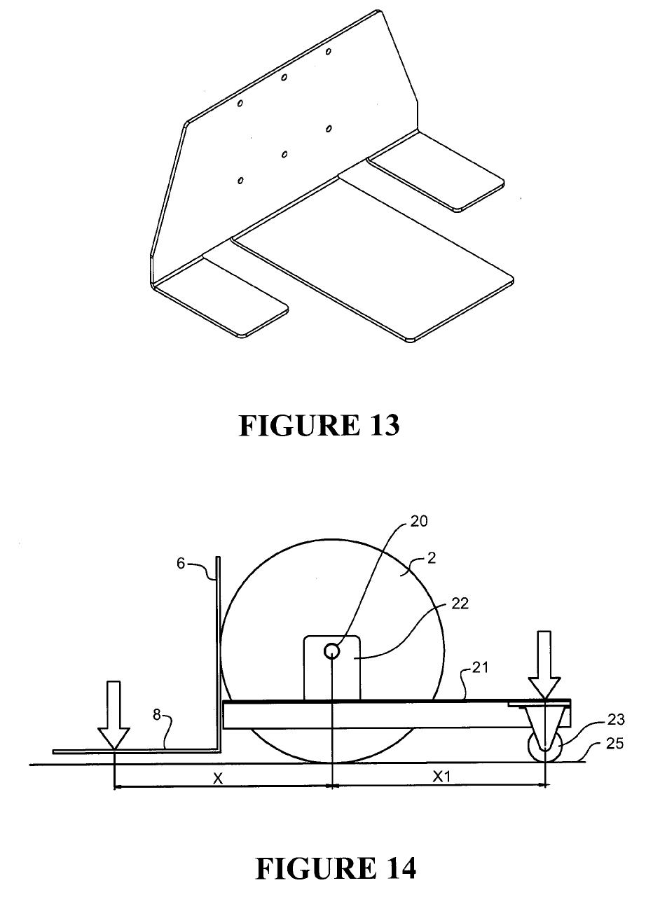

The lifting surface 8 is a surface that extends forward from the lifting mast 6 and the base structure 1 and is adapted to slide under a load to be lifted or otherwise engage with an aperture or other type of engagement on a load so that the load can be lifted. In one embodiment, the lifting surface 8 has the following approximate dimensions: 600 mm wide×400 mm deep×260 mm height. The lifting surface 8 may optionally have a profile as shown in FIG. 13.

Preferably at least one of the control input devices 5 is operable to control the vertical movement of the lifting mast 6 and the lifting surface 8. Optionally, additional actuating devices may be included to allow tilting or yaw or side shift of the lifting surface, or a combination of, if desired to provide added versatility.

Optionally the lifting apparatus may include a camera and screen arrangement. In FIG. 7 a camera line is shown at the end of a horizontally displaced elongate member 10 attached to the top of the lifting mast 6. A signal from the camera 9 can be carried to a screen 11 located where an operator may easily view. The camera 9 and screen 11 arrangement may be provided in such circumstances where an operator is unable to view the course ahead because the stack is high enough to obscure their vision. Optionally visual indicators such as one or more flashing lights may be located at the top end of the lifting mast 6 to visually signify operation of the lifting apparatus to other proximate personnel.

FIG. 14 shows a side view of the base of the lifting apparatus according to another embodiment of the invention. Two driving wheels 2 having centre 20 are shown in axial alignment. The wheels 2 are connected to the base platform 21 by way of an axle support structure 22. However, the drive wheels 2 may be attached to the platform 21 by any appropriate means, such as by connecting the wheels 2 each to a motor, wherein the motor is attached to the platform 21. The operator may stand on a platform 21. At the forward section of the platform 21 is a lifting mast 6 and a lifting surface 8. A rearward support wheel is shown as located to an aft portion of the underside structure 21, relative to the longitudinal plane of the lifting apparatus as denoted A-B.

Preferably the aft support wheel 23 comprises at least one wheel, and is preferably two or more wheels. Preferably each aft support wheel 23 is freely pivotable about the attachment to the platform structure 21. Preferably the support wheel is a caster wheel.

During operation of the lifting apparatus the centre of balance of the apparatus is located between the main driving wheels 2 and the rearward located support wheel(s) 23. To prevent the lifting apparatus from tilting forward, the centre of balance must be located between the centre of the driving wheels 2 and the rearward support wheel(s) 23. The lifting apparatus will tilt forwards when a mass located on the lifting surface 8 results in a greater torque about the driving wheel 2 than is countered by the torque aft of the driving wheel.

Preferably the lifting apparatus further comprises a forward support wheel 24 located between the lifting surface 8 and the driving wheels 2. Preferably the forward support wheel 24 is located above the ground surface 25 when the centre of balance of the lifting apparatus is located between the main driving wheels 2 and the rearward support wheels 23. When an operator uses the lifting apparatus to lift an object on the lifting surface the centre of balance of the lifting apparatus is shifted forward of the centre of the driving wheels thereby tilting the apparatus forward such that the forward located support wheel 24 comes into contact with the ground surface 25. To facilitate the lifting surface sliding under a load to be lifted the operator may lower the leading edge of the lifting surface to ground level or substantially dose to the ground using the lifting mast 6. Additional mass may be selectively provided at the rear of the lifting apparatus to ensure a rearward centre of mass in such instances where no load is on the lifting surface.

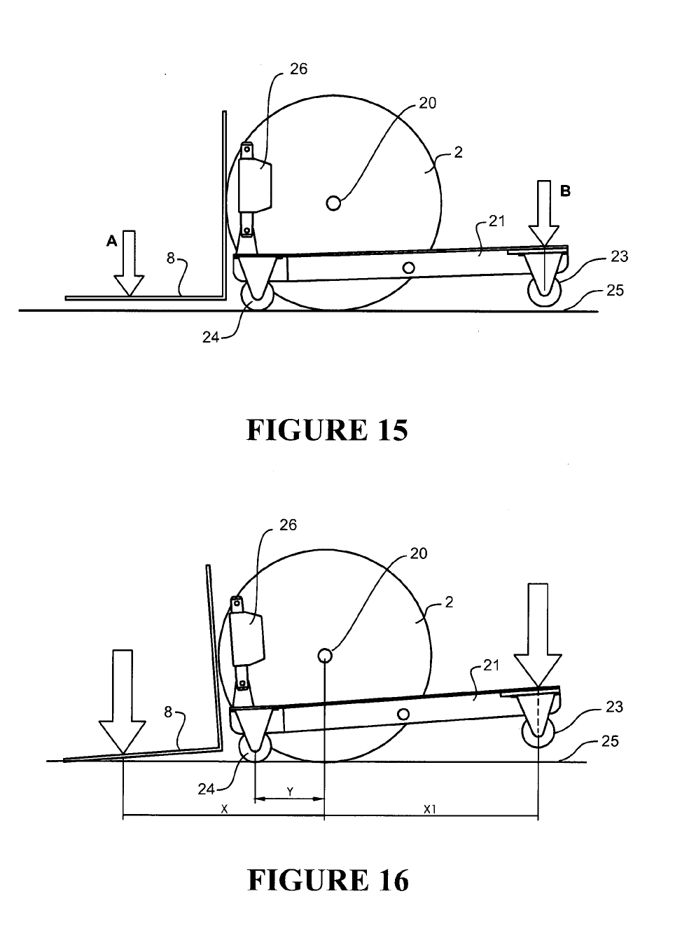

FIG. 15 shows a variation of the embodiment of FIG. 14 comprising the forward support wheel 24 connected to an actuator 26. The actuator 26 is operable to raise and lower the forward located support wheel 24 relative to the structure 21. It should be noted that the forward located support wheel 24 may optionally comprise a plurality of forward located support wheels each adapted to be raised and lowered together. Preferably each of the forward located support wheels 24 is actuated by one or more actuator(s) to be raised or lowered in unison.

In FIG. 15 the forward located support wheel 24 is shown raised above the ground surface 25. In FIG. 16 the forward located support wheel 24 is again shown in a raised position, however a load is now located on the lifting surface 8. The load can be located on the lifting surface by driving the lifting apparatus forward such that the lifting surface slides beneath the load. The load on the lifting surface 8 causes the forward located support wheel 24 be pushed downward and come into contact with the ground surface 25 and the rear located support wheel 23 to be raised from the ground surface 25 by virtue of the structure 21 tilting or pivoting forward about pivot point 20 provided by the driving wheels 2.

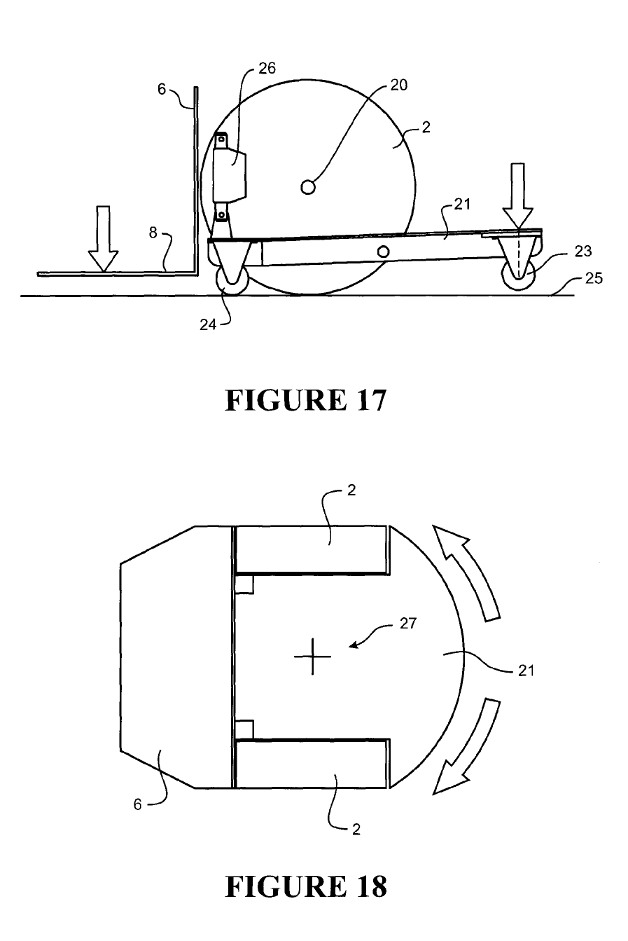

FIG. 17 illustrates the lifting apparatus with the forward located support wheel 24 actuated from an upward position into a downward position by the actuating device 26.

When actuated downward, the forward located support wheel 24 is driven into the ground surface 25 to raise the lifting surface 8 and pivot the platform structure 21 about the pivot point 20 of the driving wheels 2. The lifting surface then has clearance above the ground surface 25 and the lifting apparatus can be maneuvered by way of applying a driving force to the driving wheels 2 to transport the load that has been picked up to another location.

In some embodiments it may be desirable to have the centre of balance of the lifting apparatus permanently located between the driving wheels 2 and the forward support wheel 24. Counterweights may be omitted and an operator need not use their body weight to shift the desired centre of balance the apparatus. The particular centre of balance may be achieved by appropriate positioning of devices with significant mass, such as batteries, or by selective longitudinal placement the drive wheels relative to the other components of the lifting apparatus. The rear located support wheel 23 may optionally be omitted in such constructions. In this way, raising and lowering the wheel provides a tilting effect to the lifting apparatus. The tilting effect allows the lifting surface to be lowered to ground level such that it can be driven beneath a load to be lifted. The front wheel may then be actuated downward to raise the lifting surface so that the load can be transported without the lifting surface contacting the ground while the lifting apparatus is moving.

An example of the counter balance requirement and centre of balance may be analysed, with reference to FIG. 16, and determined by the following where:

A=LIFTING LOAD

CB=COUNTER BALANCE MASS

L=LIFTER

X=600 mm

X1=400 mm

Y=150 mm

L=200 kg

Counter Balanced Force Calculation

$$\begin{matrix}A \times X = X 1 \times CB \\ CB = ( A \times X ) / X 1 \\ = ( A \times 600 ) / 400 \\ = 1.5 \times A\end{matrix}$$

Counter Balancing Force Calculation

$$A \times ( X - Y ) = ( X 1 \times CB ) + ( Y \times L )$$

$$\begin{matrix}CB = ( ( A \times ( X\_Y ) - ( Y \times L ) / X 1 \\ = ( ( A \times ( 600 - 150 ) ) - ( 150 \times 2000 ) ) / 400 \\ = 0.375 \times Z\end{matrix}$$

FIG. 18 shows a top view of the lifting apparatus having a pair of driving wheels 2 in axial alignment. The base structure 21 provides a space in which an operator may sit or stand. The driving wheels 2 are rotatably affixed to the structure 21.

By driving each of the driving wheels according to a different speed, direction, or both, the lifting apparatus is able to be pivoted about a centre of rotation 27 located between the driving wheels 2. The ability to rotate about the centre of rotation 27 provides that the lifting apparatus may pivot within a tight space.

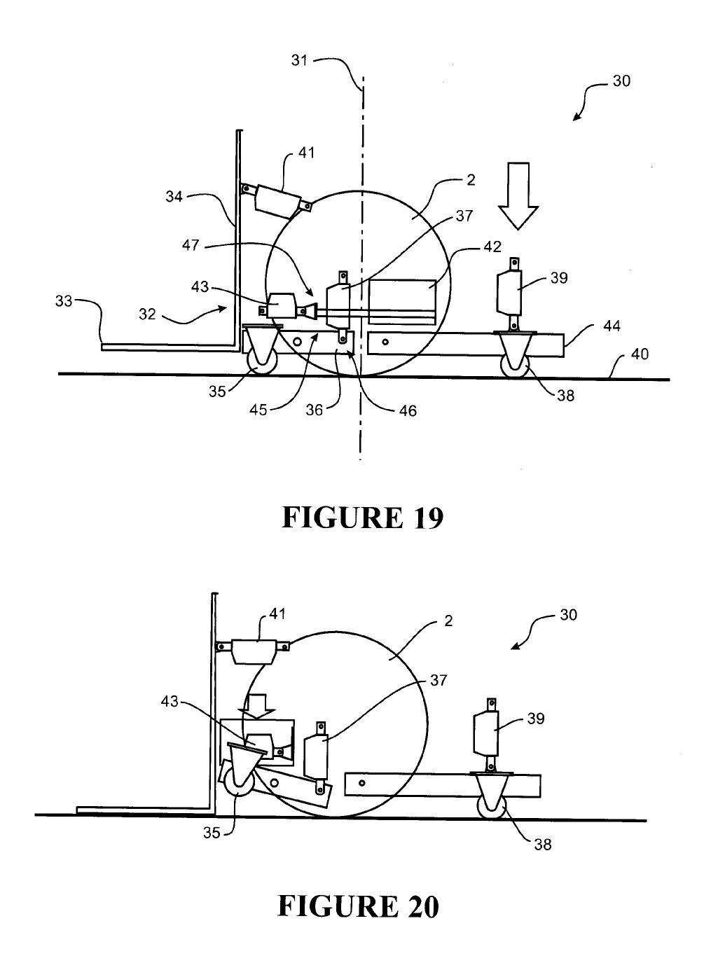

FIG. 19 shows a further embodiment of the lifting apparatus which is a variation of the above embodiments. The lifting apparatus 30 has a first and a second drive wheel 2 aligned about an axis of rotation. The rotational centre of the drive wheels 2 provide an optimum centre of balance point 31 of the lifting apparatus.

The lifting apparatus 30 has a structure having a longitudinal dimension defined perpendicular to the aids or rotation of the drive wheels and is adapted to rotatably support the first and second chive wheels. Preferably the structure can pivot about the axis of rotation of the drive wheels.

At motive device adapted to drive, either together or independently, the drive wheels such that the lifting apparatus can be maneuvered.

A lifting mechanism 32 is attached to the front of the structure. The lifting surface preferably includes a lifting surface 33 and mast 34 that is operable to raise, lower and tilt the lifting surface such that a load can be retained on the lifting surface when the lifting apparatus is in motion. An tilt actuator 41 may be included to tilt the lifting mechanism and thereby incline the lifting surface 33.

The lifting apparatus has a one or more forward support wheels 35 located between the first and second drive wheels and the lifting mechanism 32. An actuator 37 is coupled to the base of the lifting apparatus and the front support wheels such that the front support wheels can be raised, lowered or leveled relative to the lifting apparatus and a ground plane 40. The actuator may attach to the front wheels directly or it may attach to a pivotable level arm 36 to which the support wheels 35 are attached. A pivotable level arm may be desired to provide wheel stability, increased torque on the wheel or finer resolution of the wheel displacement.

The lifting apparatus further has one or more aft support wheels 38 located aft of the drive wheels 2. An aft wheel actuator 39 is coupled to the lifting apparatus and the aft wheel. The actuator can be extended or retracted such that the aft support wheels can be raised, lowered or leveled relative to the lifting apparatus and a ground plane 40 in a similar manner to how the front support wheels are operated. The actuator 39 may attach to the aft wheels directly or it may attach to a pivotable level arm to which the aft support wheels 38 are attached.

Each of the front support wheel actuator 37 and the aft support wheel actuator 39 are preferably operated by receiving an electrical signal indicative of a direction of desired actuation.

The lifting apparatus preferably includes a ballast weight 42. The ballast weight may include items such as batteries used to provide electrical power to devices on the lifting apparatus. The ballast 42 is preferably longitudinally movable relative to axis of rotation of the drive wheels 2 to provide control of the location of the centre of balance 31. A ballast actuator 43 may be provided to move the ballast to a desired location. For example, when a load is placed on the lifting surface 33 the centre of balance is moved forward, the ballast may be moved aft of the axis of rotation of the drive wheels such that the centre of balance is moved rearward. Control of the centre of balance is possible by controlling the distance of the balance from the axis of rotation and the weight of the ballast.

A platform 44 is preferably provided to allow an operator of the lifting apparatus to stand or sit. The centre of balance may be moved with the position of the operator and that position may in, in some circumstances, be dynamic. For example, an operator may move forward on the platform to move the centre of balance forward. Or an operator may move rearward on the platform to move the centre of balance rearward.

A control system, or controller, is preferably housed on the lifting apparatus and is configured to receive a number of sensor inputs, make control decisions and generate a number of control outputs to effect control decisions.

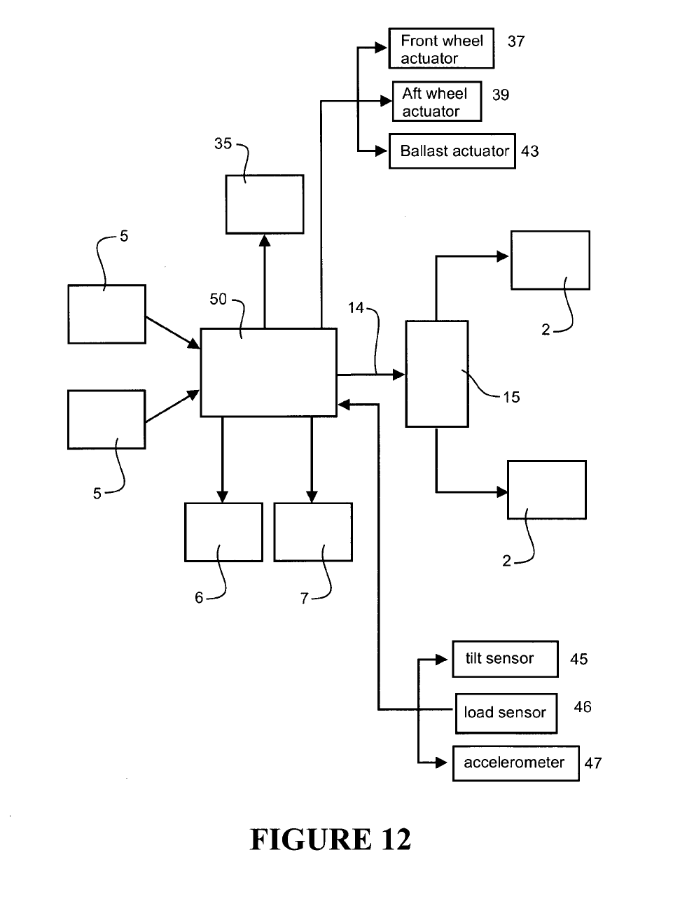

FIG. 12 shows an example of the controller that may be used with the lifting apparatus of FIG. 19. The controller 50 is preferably configured to receive inputs from an operator control input device 5 relating to drive forward or reverse drive, left or right turning, or rotation of the lifting apparatus and movement of the lifting mechanism. The controller 50 outputs a signal in response to the movement input and outputs a control signal that may be provided to motors or a motor control device 15 to drive the first and second driving wheel 2 in the same direction at the same or different speeds, the latter for turning left or right, drive the first and second driving wheel in opposing directions, drive the first wheel while the second wheel is stationary, or drive the second wheel while the first wheel is stationary.

Similarly, the controller 50 may receive an input signal relating to desired raising, lowering or tilting of the lifting mechanism and in turn output a signal to actuators in the lifting mechanism to effect the desired operation.

The controller 50 may also be used to balance the lifting apparatus and lifting mechanism about the centre of rotation of the driving wheels thereby enabling an operator to drive the lifting apparatus balanced, or substantially balanced on the drive wheels.

The controller is configured to receive signals relating to the desired movement of the lifting mast 6 including tilting, raising or lowering of the lifting surface or engagement of hooks 7 may be received and the control system in turn generates and outputs signals to the lifting mechanism to effect the desired operation. The processor 13 preferably also outputs a signal relating to the raising and lowering of the front support wheel 36. The movement signal 14 may in turn be processed by a motor control system 15. The motor control system 15 controls movement of each of the drive wheels 2.

The controller is configured to receive a number of inputs signal relating to measurements made by various sensors. Sensor inputs include an input from a load sensor 46 adapted to measure the load on the front support wheels and an input from a sensor 45 adapted to measure the tilt angle of a lever arm supporting the front support wheels, that is whether the front support wheels are in a raised, level or lowered position relative to the ground plane. A speed sensor may also be adapted to measure the speed of the lifting apparatus over the ground and that measurement input to the controller. An accelerometer or tilt sensor 47 is adapted to measure the tilt angle of the lifting apparatus and input that measurement to the controller.

The controller is configured to generate an output for each of the front support wheel actuation device 37 and the aft support wheel actuation device 39 which may be in response to receiving a signal from the sensor inputs 45, 46 or in response to receiving an operator control input 5.

The sensor inputs and operator control inputs generally relate to a number of scenarios where the lifting apparatus is to be used. For example, the sensor inputs may indicate high or low speed movement of the lifting apparatus and the controller thereby moves the front and aft support wheels and ballast to a position best suited for stability. In another example, the lifting apparatus may be approaching an inclined or declined ground plane and may need to output signals to the support wheel actuators and ballast actuator to move the support wheels and ballast to a position that best accommodates a gradient transitions or operation on a gradient.

The controller may use the combination of the sensor inputs may be used to determine various states of the lifting apparatus. The controller determines the state of the lifting apparatus by comparing the sensor inputs to a stored set of sensor inputs that represents a desired or particular state. The controller may then determine a control output most suitable for stabilising the lifting apparatus while loading or unloading of the lifting surface, transportation of a load and negotiating gradients.

Preferably the controller can determine states such as high or low speed movement, loaded or unload operation, transitioning from any of a level, inclined or declined ground plane to any other of a level, inclined, or declined ground plane. Preferably the controller uses one or snore of the load sensor 46, the angle of the arm 45 or the tilt of the lifting apparatus to determine those states. Preferably the controller operates to control the balance of the lifting apparatus such that the centre of balance is maintained as close to the axis of rotation of the driving wheels as possible during all states. This may be performed, for example, by tilting the lifting apparatus forward or backward by actuation of the front and rear support wheels, or may be performed by actuating the ballast forward or tart of the driving wheels.

For example, the controller may determine a load has been placed on the lifting surface 33 when the arm tilt sensor 45 indicates the support wheels are level, the load sensor 46 indicates a load has increased and the accelerometer 47 indicates the lifting apparatus has tilted forward.

In another example, the controller may tilt the lifting apparatus forward by moving the ballast forward and raising the front support wheel or lowering the rear support wheel.

In another example, the controller may tilt the apparatus aft by actuating the ballast aft and raising rear support wheel or lowering the front support wheel.

In another example, the controller may determine the front support wheels have impacted an inclined surface when the load on the front support wheels increases, the tilt angle of the arm supporting the front support wheels increases and the accelerometer 47 indicates the lifting apparatus has tilted backward. The controller may respond by causing the ballast to shift rearward to stabilise the lifting apparatus or counter balance a lifted load.

In another example the controller may determine the front support wheels have impacted an inclined surface by allowing the front actuator to hang the front support wheel freely. In this way, when the front wheel hits an incline the actuator will be moved upwards and that movement or change in angle can be sensed.

The controller may compare the load input for the forward support wheels to a desired load input and output a signal to cause the actuator 37 to lower the one or more support wheels when the indicative load is less than the desired load, or raise the one or more support wheels when the indicative load is more than the desired load.

FIG. 20 illustrates an example scenario that may represent the loading apparatus moving at low speed or prepared for loading or unloading. Preferably the weight of the lighting apparatus is centered mostly behind the centre of balance such that the front support wheels are unloaded. The front support wheels 35 are can be moved into a raised position to avoid unnecessary wear or friction. The ballast 42 is preferably moved to a forward position to remove unnecessary weight from the rear support wheels 38.

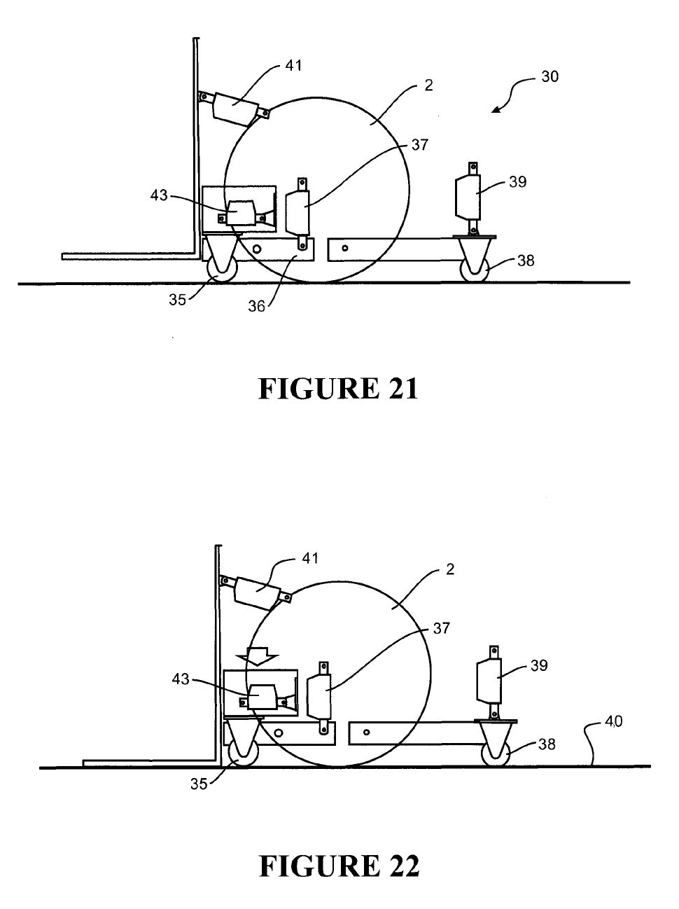

FIG. 21 illustrates an example scenario that may represent the loading apparatus travelling at high speed while unloaded. The speed of the lifting apparatus may be input to the controller by way of a ground speed sensor, a wheel speed sensor or by feedback from motive devices used to drive the main wheels 2. Preferably controller 50 raises the lifting mechanism from the ground plane for clearance. Preferably the front and aft support wheels 35, 38 are positioned level with the ground plane. The aft wheel 38 for stability and the forward wheels 35 for resistance to forward tipping when braking.

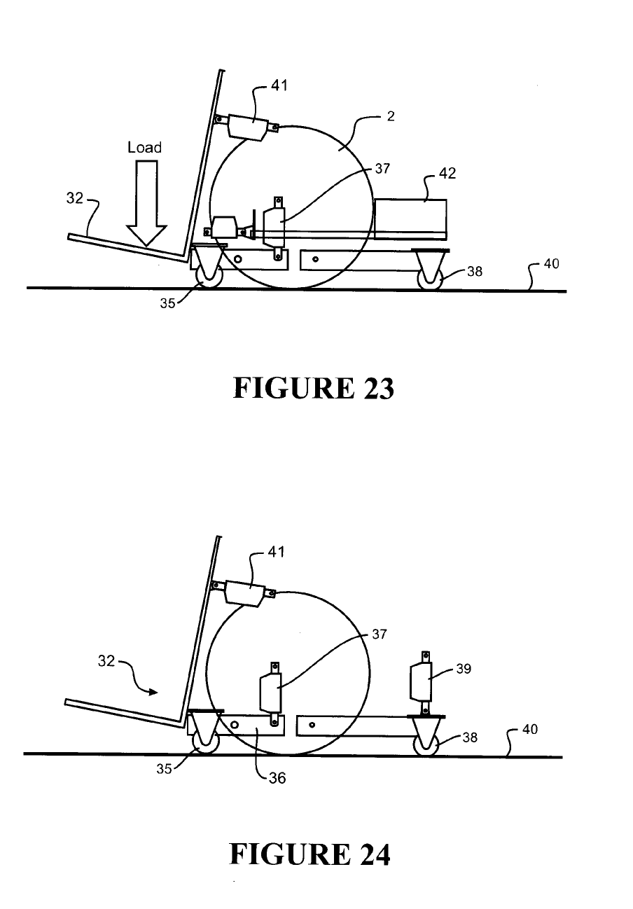

FIGS. 22 and 23 illustrate an example scenario that may represent the loading apparatus when transitioning from an unloaded to a loaded state. In FIG. 22 the lifting surface is preferably positioned proximate the ground such that a palletised load can be engaged. The front and aft support wheels are positioned level with the ground plane. In FIG. 23 the lifting surface is raised from the ground. The load on the front support wheels will increase and the increased load will be sensed by the load sensor and input to the controller. Preferably the ballast 42 is moved aft of the drive wheels 2.

FIG. 24 illustrates an example scenario that may represent the loading apparatus in a loaded state and travelling over level ground. The load sensor adapted to measure the load on the front support wheels will output a signal to the controller indicative of a steady front load. The controller will output a signal to cause the ballast to be moved aft of the drive wheels. The controller will output a signal to ensure the front support wheel actuator is locked in a level position.

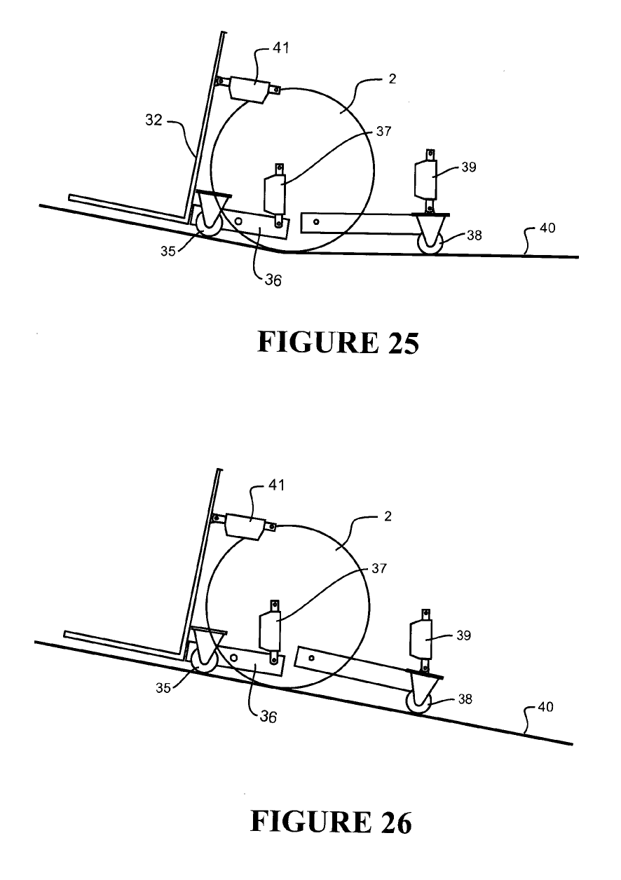

FIG. 25 illustrates an example scenario that may represent the loading apparatus encountering an inclined gradient 40 while carrying a load. The load sensor 46 will sense an increased load on the front support wheels 35 and the tilt angle of the lifting apparatus will increase. In response, the controller is configured to move the ballast aft of the drive wheels and raise the front support wheels.

FIG. 26 illustrates an example scenario that may represent the loading apparatus travelling up an inclined gradient while carrying a load. In response, the controller is configured to move the ballast forward of the driving wheels, to raise the front support wheels and lower the rear support wheels.

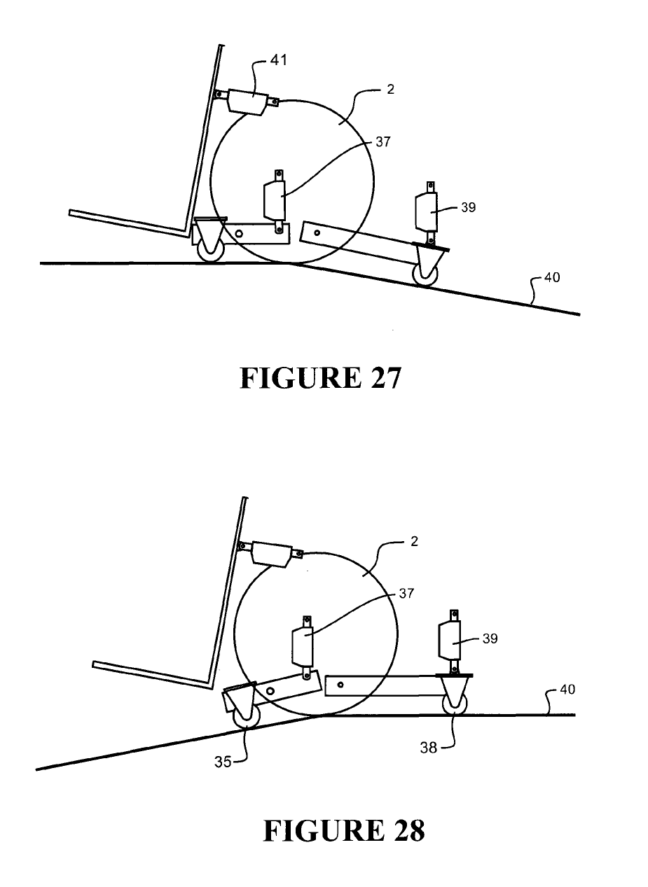

FIG. 27 illustrates an example scenario that may represent the loading apparatus transitioning from an inclined surface to a level surface. The load sensor 46 senses a decrease in load on the front support wheels. In response, the controller moves the ballast rear of the drive wheels and the rear support wheels are raised to a level position.

FIG. 28 illustrates an example scenario that may represent the loading apparatus transitions from a level surface to a declining surface. The load sensor 46 senses a decrease in load on the front support wheel. In response, the controller moves the ballast rear of the drive wheels and the front support wheels are actuated to a lowered position. The aft support wheels are actuated to a raised position.

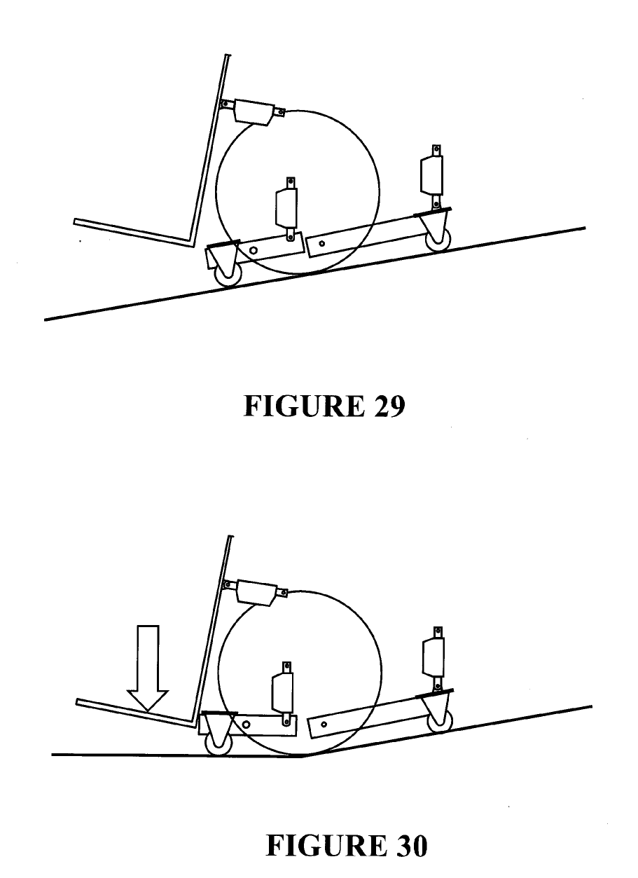

FIG. 29 illustrates an example scenario that may represent the loading apparatus is travelling on a declining surface. The load sensor 46 senses the load on the front support wheels increases. In response, the controller causes the first actuator to lower the first support wheels, causes the second actuator to raise the aft support wheels, causes the third actuator to displace the ballast aft of the axis of rotation of the driving wheels and causes the lifting surface to be in a raised or upwardly tilted position.

FIG. 30 illustrates an example scenario that may represent the loading apparatus transitioning from a declining surface to a level surface. The load sensor senses 46 the load on the front support wheels is increasing and the tilt angle is also increasing. In response, the controller causes the first actuator to level the first support wheels, causes the second actuator to raise the aft support wheels, causes the third actuator to displace the ballast aft of the axis of rotation of the driving wheels, and causes the lifting surface to be in a raised or upwardly tilted position.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope or spirit of the invention as defined in the accompanying claims.

1.-33. (canceled)

34. A lifting apparatus comprising:
a lifting mechanism,
first and second drive wheels,
one or more support wheels operatively coupled to the drive wheels,
a sensor adapted to provide an output indicative of the load on the one or more support wheels, and
a control system configured to receive the output from the sensor, and generate a signal for operating an actuation device to maintain the load on the one or more support wheels to substantially balance the lifting apparatus about the drive wheels.

35. The lifting apparatus as claimed in claim 34, wherein the first and second drive wheels are aligned about and spaced along an axis of rotation.

36. The lifting apparatus as claimed in claim 35, further comprising a support structure adapted to rotatably support, and balance about the axis of rotation of the first and second drive wheels.

37. The lifting apparatus as claimed in claim 34, further comprising at least one motive device adapted to drive, either together or independently, the first and second drive wheels such that motion of the lifting apparatus is effected.

38. The lifting apparatus as claimed in claim 34, wherein the lifting mechanism includes a lilting surface and an actuator adapted to at least lower or level the lifting surface such that a load is engaged, or raise or upwardly tilt the lifting surface such that a load is retained on the lifting surface when the lifting apparatus is in motion.

39. The lifting apparatus as claimed in claim 38, wherein the control system is further configured to output a signal representative of desired movement of the lifting surface.

40. The lifting apparatus as claimed in claim 38, wherein the control system is further configured to have input from one or more sensors including:
one or more sensors adapted to measure the lifting apparatus speed over ground,
one or more sensors adapted to measure the tilt angle of the lifting apparatus about the axis of rotation,
a load sensor adapted to measure a load on the lifting surface, or
a lifting mechanism control sensor adapted to indicate a desired raising or lowering of the lifting surface.

41. The lifting apparatus as claimed in claim 38, wherein the control system is further configured to have input from at least an operator, or an operational guidance system, including:
a signal indicative of desired movement of the lifting surface,
a signal indicative of desired movement of the first or second drive wheel, or
a signal indicative of desired movement of the actuation device.

42. The lifting apparatus as claimed in claim 41, wherein the operational guidance system is an autonomous guidance system.

43. The lifting apparatus as claimed in claim 38, further comprising a platform for supporting an operator.

44. The lifting apparatus as claimed in claim 38, wherein the one or more support wheels includes
one or more forward support wheels located between the first and second drive wheels and the lifting surface, and a first actuation device adapted to raise and lower the one or more forward support wheels.

45. The lifting apparatus as claimed in claim 38, wherein the one or more support wheels includes one or more aft support wheels located longitudinally aft of the drive wheels, and a second actuation device adapted to raise and lower the one or more aft support wheels.

46. The lifting apparatus as claimed in claim 38, wherein the one or more support wheels includes one or more forward support wheels located longitudinally forward of the drive wheels, one or more aft support wheels located longitudinally aft of the drive wheels, and a first and a second actuation device adapted to raise and lower the one or more forward and aft support wheels.

47. The lifting apparatus as claimed in claim 46, wherein the first actuation device and second actuation device are independently operable to cause movement of together or independently, the one or more forward, or aft, support wheels to at least raised, level and lowered positions with respect to a ground plane.

48. The lifting apparatus as claimed in claim 46, wherein the control system is further configured to output one or more signals representative of desired actuation of the first or second actuation devices so as to cause raising or lowering of the one or more forward support wheels, or the one or more aft support wheels, or both.

49. The lifting apparatus as claimed in claim 46, wherein the control system is further configured to output a signal for energizing at least one motive device to:
drive the first and second driving wheel in a same direction,
drive the first and second driving wheel in opposing directions,
drive the first wheel while the second wheel is stationary, or
drive the second wheel while the first wheel is stationary.

50. The lifting apparatus as claimed in claim 46, further comprising a third actuation device adapted to displace a ballast forward and aft of an axis of rotation of the drive wheels.

51. The lifting apparatus as claimed in claim 50, wherein the control system is configured to output a signal representative of desired actuation of the third actuation device so as to cause displacement of the ballast.

52. The lifting apparatus as claimed in claim 46, wherein the control system is further configured to:
receive an input indicative of the load on the one or more forward support wheels,
compare the input indicative of the load on the one or more for support wheels to a desired load,
output one or more signals to control actuation of the first or second actuation device to maintain the load on the one or more forward support wheels substantially similar to the desired load.
